(19) United States
(12) Patent Application Publication
(10) Pub. No.: US 2005/0203213 A1
(43) Pub. Date: Sep. 15, 2005

(54) Aqueous liquid cleaning composition comprising visible beads

(75) Inventors: Baptiste Pommiers, Etterbeek (BE); Kevin George Goodall, Tervuren (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/899,745

(22) Filed: Jul. 27, 2004

(30) Foreign Application Priority Data
Aug. 1, 2003 (EP) 03447204.3

(51) Int. Cl. C08K 9/10

(52) U.S. Cl. 523/210

(57) ABSTRACT

The present invention relates to a pourable cleaning composition comprising a plurality of stably suspended, visibly distinct beads, and at least two structurants selected from different groups of structurant.

### CROSS REFERENCE TO RELATED APPLICATIONS

This application claims the benefit of EP Application No. 03447204.3, filed Aug. 1, 2003, which is incorporated by reference herein.

### FIELD OF THE INVENTION

The present invention relates to aqueous cleaning compositions comprising visible beads and at least two structurants. The structurants of the invention are selected from at least two different groups of compounds.

### BACKGROUND OF THE INVENTION

The commercial marketing of cleaning products often involves the use of distinctive product aesthetics to help differentiate one given product from other commercially available products of the same general type. Colored, e.g., dyed or pigmented, particles such as speckles or beads are sometimes used to create such distinctiveness. Generally, distinct particles in cleaning products should be larger than 200 microns to be easily visible to the consumer.

The presence of visibly distinct particles such as beads in cleaning products can provide a signal to the consumer that the product has been changed and improved from previously marketed or available products without such beads. Thus, such a signal can serve to indicate that altered, new and/or additional cleaning ingredients have been added to the product or that the product contains ingredients which alter the overall experience of using the product. Such new or additional ingredients may actually be incorporated into the visible beads themselves or may simply be incorporated into the liquid matrix of the product with their presence signaled by the beads. If new and/or additional composition components are incorporated into the visibly distinct beads, such beads may then serve the additional purpose of helping to stabilize or protect such incorporated product ingredients from interaction with or degradation by other components of the composition. If beads are used for this purpose, the beads must be constructed so as to partially or completely isolate the carried materials from any other components in the composition which might be incompatible with such carried ingredients. Moreover, such beads must also be able to suitably release their carried ingredient into the wash liquor when the composition is used for its cleaning purpose.

In a granular cleaning composition context, suspension of visible particles in the product is fairly straightforward. This is because the formulator is free to chose visibly distinct, e.g., dyed or pigmented, particles which can be matched in density and particle size to the bulk granular detergent. Such particles are easily dispersed throughout the granular matrix, and there is little likelihood of destructive interaction between the visible particles and the other matrix ingredients.

In a liquid cleaning composition context, however, and especially with respect to aqueous liquid compositions, it is a challenge to stably suspend particles in liquid products during manufacture, shipping, storage and during use. The formulator must use beads which are both relatively insoluble in the aqueous liquid matrix and are strong enough to withstand the rigors of commercial scale composition preparation, shipping and distribution.

Preferred suspension of the beads in liquid matrices also requires suitable formulation of the aqueous liquid matrix of the product. To stably suspend beads, liquid compositions should ideally be “structured” so that the liquid portion thereof has suitable rheological characteristics to maintain the beads suspended within the composition and prevent them settling to the bottom of the container. Thus the matrix rheology must be such that it is sufficiently viscous that the beads do not settle out of the product upon prolonged storage yet not so viscous that the product cannot be readily poured. It is therefore preferred that the “structurant” materials which are added to the composition would be ones which impart “shear-thinning “characteristics to the matrix without creating any aesthetic or other difficulties such as opacity, instability or unacceptable expense.

It has however been found that in some circumstances the use of one structurant alone may not be sufficient to provide the aesthetics required. Whilst not wishing to be bound by theory, it is believed that a structurant provides at least one of two structuring events. The first structuring event is that of providing structuring of the composition immediately or shortly after a deformation event. A deformation event is defined as an action which cause the fluid to deform, flow or more generally be displaced from its initial position; for example, pouring, shaking, squeezing of the composition or a container containing the composition. This structurant may be characterized as possessing a fast recovery or rebuilding time, meaning the time to reestablish its initial state. The second structuring event provides the long term structuring of the composition required when the fluid is at rest, for example over prolonged periods of storage. This structurant may be characterised as possessing a long recovery or rebuilding time upon deformation and subsequent rest. Whilst it is possible that one structurant alone can provide both structuring events it has been generally found that said structurant must be incorporated into the cleaning composition at such a level as to raise the cost of the composition or negatively impact viscosity, dissolution or transparency/translucency of the composition. It is therefore an object of the present invention to provide a cleaning composition comprising a first and a second structurant.

### SUMMARY OF THE INVENTION

According to the present invention there is provided a cleaning composition in the form of a pourable, externally-structured, aqueous liquid matrix having dispersed therein a plurality of stably suspended, visibly distinct beads, said composition comprising;
a) a first structurant selected from the group consisting of non-polymeric crystalline, hydroxy-functional materials which form thread-like structuring systems throughout the aqueous liquid matrix of said composition upon in situ crystallization therein; and
b) a second structurant which is a polymeric structurant selected from the group consisting of polyacrylates and derivatives thereof; polysaccharides and derivatives thereof; polymer gums and combinations thereof; and

### DETAILED DESCRIPTION OF THE INVENTION

The compositions of the present invention may be formulated for use in any cleaning operation. For example the compositions of the present invention may be formulated as laundry washing detergent, hand dishwashing liquids, hard surface cleaners, toilet bowl cleaners, shampoos, shower gels, skin cleansers etc

The compositions of the present invention are aqueous meaning that they comprise water. Preferably the compositions comprise water at a level of from 30% to 75%, more preferably from 35% to 72%, most preferably from 40% to 70% by weight of the compositions herein.

Visibly Distinct Beads

The compositions of the present invention comprise visibly distinct beads. For the purposes of this invention, the term “visibly distinct” has its usual and conventional meaning which is that the beads, within the compositions herein, must be readily apparent and discernible to an observer inspecting the composition. Suitable beads for use in such compositions are available in the prior art. The beads may be selected from microcapsules or porous, sponge-like beads. Microcapsule beads comprise a shell surrounding a core. Said core may comprise a void or a separate mass. Porous beads are generally homogenous and present a sponge-like structure. Either type of bead may serve as a carrier for an ingredient of the composition.

Bead visibility is, of course, determined by a number of interrelated factors including size and shape of the beads, the various optical properties of the beads and the liquid composition they are dispersed within. A transparent or translucent liquid matrix in combination with opaque or translucent beads will generally render the beads visible if they have a minor dimension of 0.2 mm or greater. They will generally have a diameter (or effective diameter which is the diameter of a sphere of the same mass as a non-spherical bead) in the range from 0.2 to 8 mm, preferably from 0.3 mm to 3 mm and more preferably from 0.5 to 4 mm. These ranges are preferred from the standpoint that the beads can be visualised with the naked eye and from ease of manufacture.

Even transparent beads in a transparent liquid matrix might be visibly distinct if the refractive properties of the beads and liquid are sufficiently different. Furthermore, even beads dispersed in a somewhat opaque liquid matrix might be visibly distinct if they are big enough and are different in color from the matrix. The beads may be of any shape. More preferably the beads are substantially rounded, more preferably substantially spherical.

The beads used in the compositions of this invention must be strong enough and stable enough to withstand being introduced into and processed within commercially prepared liquid products. The beads must also be physically and chemically stable within the liquid compositions for prolonged periods of storage and shipping. However, where the beads comprise an active ingredient they are preferably dissolvable, crushable, squeezable or ruptureable during use of the composition, such that the active ingredients may be released. When the composition is used to formulate a liquid laundry product, it is preferred that the beads and their contents must be able to dissolve or disintegrate in a manner and to the extent that the beads, or visible residues therefrom, are not deposited onto fabrics being laundered in such dilute aqueous washing liquors.

The present compositions may comprise beads at a wide variation of levels. The beads are typically included in the present compositions at a level of from 0.001% to 5% by weight, preferably from 0.05% to 4% by weight, more preferably from 0.1% to 3% by weight, of a plurality of visibly distinct beads.

The beads can be made from a wide variety of materials. Such materials are typically polymeric and are designed to resist becoming solubilized in the chemical matrix of the present compositions. Non-limiting examples of materials suitable for making the beads herein include urea-formaldehydes, melamineformaldehydes, phenolformaldehydes, gelatin, poly(vinyl alcohol), poly(vinyl pyrrolidone), polyacrylates, polyamides, polyurethane, polymethacrylates, polyepoxides, cellulose acetate, cellulose nitrate, cellulose acetate butyrate, ethyl cellulose polyester, polychlorotrifluoroethylene (e.g. KEL-F), ethyl/vinyl acetate, saran, polystyrene, zein, paraffin wax, animal wax, vegetable wax, microcrystalline wax, polyethylene wax, agar, polyoxymethylene urea, methophenols and the like. Preferred bead materials include gelatin, agar, polyoxymethylene urea, methophenols and mixtures thereof. Other suitable bead materials are disclosed in, e.g., U.S. Pat. Nos. 2,800,458; 3,159,585; 3,516,846; 3,533,958; 3,697,437; 3,888,689; 3,996,156; 3,965,033; 4,010,038; 4,016,098; 4,087,376; 5,591,146; UK Patent Nos. 2,006,709 and 2,062,570. Preferred microcapsule beads are available from Lipotechnologies under the tradename lipocapsules. Preferred porous beads are made from agar and are available from Lipotechnolgies under the tradename Lipospheres.

A variety of processes known in the art can be used to make the beads herein. Examples of processes for making microcapsule beads are described in U.S. Pat. Nos. 2,800,458; 3,159,585; 3,516,846; 3,516,941; 3,533,958; 3,697,437; 3,778,383; 3,888,689; 3,965,033; 3,996,156; 4,010,038; 4,016,098; 4,087,376; 4,089,802; 4,100,103; 4,251,386; 4,269,729; 4,303,548; 4,460,722; and 4,610,927; UK Patent Nos. 1,156,725; 1,483,542; 2,041,319 and 2,048,206; and Benita, Simon (ed.), MICROENCAPSULATION: METHODS AND INDUSTRIAL APPLICATIONS (Marcel Dekker, Inc. 1996). Porous, sponge-like beads are prepared by an extrusion process and consist of many small droplets or particles trapped within a polymer matrix more like a sponge than a capsule. Said beads are available from Lipotechnologies.

Other preferred beads suitable for use herein comprise those which are in the form of a liquid core comprising an ionically charged polymeric material and a surrounding osmotically semipermeable membrane. This membrane is one which can be formed by interaction of some of the ionically charged polymer in the core with another polymeric material of opposite charge. The liquid core of the beads useful herein, in addition to containing an ionically charged polymeric material, may also comprise water, solvents and a wide variety of other materials which may or may not be ionic in nature. When used in the aqueous liquid matrices of the present invention, the semipermeable membrane permits the transfer of water or solvent between the liquid bead core and the aqueous liquid composition matrix, by osmotic effect, until equilibrium is substantially reached. This contributes to the physical stability of the beads within the composition matrix. Without being bound by theory, it is believed that when the bead-containing composition is combined with fresh water to form a wash liquor, for example during a laundering or dishwashing operation, the resulting gradient of ionic strength between the resulting wash liquor and the bead core draws water into the core. This, in turn, exerts high pressure on the bead membrane which consequently disintegrates. This mechanism contributes to the disintegration of the beads in use and to the release into the wash liquor of the bead core material, including any active ingredient, the bead may be carrying. This disintegration of the beads is generally independent of the wash water temperature.

Microcapsule beads of this type are in general prepared by forming droplets or particles containing the requisite ionically charged polymeric material, and by thereafter contacting such droplets or particles with a liquid “curing bath” containing the requisite ionic polymeric material of opposite charge. This contact of droplets/particles with curing bath causes the interaction, e.g., reaction, of the two types of polymeric materials to occur, and this in turn forms the resulting osmotic membrane around each droplet or particle. Microcapsules of this type, and their preparation and use, are disclosed in greater detail in PCT Published Application Nos. WO 01/01927 and WO 02/055649. Especially preferred beads for use herein are the microcapsules described in detail, along with their preparation, in the commonly owned, concurrently filed patent applications of The Procter & Gamble Company, which are EPO Application No. EP ______, (P&G Case CM2771F) and EPO Application No. EP ______, (P&G CaseCM2772F).

The ionically charged polymeric mateials used to form both the core and the membrane of the beads herein may be either cationically or anionically charged. Such materials are also referred to as “polyelectrolytes”. Cationic and anionic polyelectrolytes must be capable of reacting with each other to form a complex which will function as the semipermeable membrane of the beads. Such polyelectrolyte materials may be either naturally occuring polymers or synthetic polymers. (For purposes of this invention, the term “polymers” includes oligomers.). The core of the beads may comprise the anionic polyelectrolyte while the curing bath, e.g., curing solution, which reacts with this core to form the bead-encapsulating membrane may contain the cationic polyelectrolyte. Alternatively, it may be the other way around with the core comprising the cationic polyelectrolyte and the curing bath containing the anionic polyelectrolyte. Preferably, the anionic polyelectrolyte is in the core.

Suitable anionic natural polyelectrolytes may be selected from anionic gums. Suitable anionic gums include alginates, carrageenan, gellan gum, carboxyl methyl cellulose, xanthan gum and mixtures thereof. Suitable anionic synthetic polyelectrolytes may be selected from the group consisting of polyacrylates and polymethacrylates, polyvinyl sulphates, polystyrene sulphonates, polyphosphates and mixtures thereof.

Suitable cationic natural polyelectrolytes may be selected from the group consisting of chitosan, chitosan derivatives such as quaternarized chitosan and aminoalkylated and quaternarized celluloses and poly-L-lysine and mixtures thereof. Suitable cationic synthetic polyelectrolytes may be selected from the group consisting of poly-(N,N,N-trialkylammoniumalkyl) acrylates, poly-(N-alkylpyridinium) salts, polyethylenimines, aliphatic ionenes, poly-(diallyldialkylammonium) salts and mixtures thereof, wherein the alkyl is preferably short chain with from 1 to about 4 carbon atoms, preferably methyl.

Preferred for use herein as the core material for the beads are solutions of sodium alginate. Droplets of such solutions are preferably contacted with a curing bath which comprises poly-(diallyldimethylammonium) chloride, chitosan polymer (having a molecular weight of from about 10 to 1,000 kDa, preferably from about 50 to 500 kDa), chitosan oligomer (having a molecular weight of from about 300 to about 9,000 Da, preferably from about 500 to about 5,000 Da) or a mixture of these chitosan polymers and oligomers. These combinations of core solution and curing bath are preferred for the short reaction time and for the low permeability of the resulting beads, especially preferred being combinations of sodium alginate with poly-(diallyldimethylammonium) chloride.

Generally the volume of the curing bath is at least 10 times, preferably at least 100 times and more preferably at least 1,000 times larger than that of a bead-forming droplet. Therefore, the amount of the polyelectrolyte in the curing bath is generally well in excess over that of the polyelectrolyte in the bead core liquid. Thus the concentration of the polyelectrolyte in the curing bath is not very critical. Generally the concentration of the polyelectrolyte in the curing bath can range from 0.5% to 5%, more preferably from 0.8% to 2%, by weight of the curing bath.

Preferably the pH of the curing bath is determined by the pH at which the curing bath polyelectrolyte will dissolve. The residence time of the droplets in the curing bath can be adjusted according to the desired thickness of the bead membrane. Generally the membrane-forming reaction in the curing bath will take place with the curing bath maintained under agitation conditions.

Preferably the curing bath for the beads will comprise a mixture of chitosan polymer and chitosan oligomer, preferably in a weight ratio of from about 5:1 to about 1:1, more preferably from about 3:1 to about 1:3. Such a combination provides a bead membrane of both good strength and a very low membrane permeability.

The bead membrane that is formed by interaction of the polyelectrolyte in the bead core liquid with the polyelectrolyte in the curing bath is one that controls the osmotic absorption behavior of the bead. Generally such a membrane is a complex that completely encapsulates the core and all of the materials which the core holds. Although it can be difficult to determine where the membrane ends and the bead “core” begins, this membrane complex will generally have a thickness typical of osmotic membranes known in the art.

Membrane permeability is such that it allows the transfer of water or solvent between the aqueous matrix of the liquid composition that holds the beads and the cores of the beads. The membrane, however, precludes the leaching out of many of the actives that can be held within the bead core. When the beads encounter aqueous media having much lower concentrations of ionic species than in the aqueous liquid matrix, such as when the beads are introduced into an aqueous washing liquor, water from the liquor is transported through the membrane and into the bead core until the bead disintegrates under the aqueous washing conditions it encounters.

The core liquid used to form the beads will preferably have a viscosity, measured at 25° C. and a shear rate of 1 sec⁻¹ ranging from 0.5 to 1000 Pa.s, more preferably a viscosity of at least about 5 to 800 Pa.s. Concentrations of polyelectrolyte ranging from 1% to 15%, more preferably from 2% to 10%, most preferably from 3% to 8%, by weight of the core liquid, will generally provide core liquids of the requisite viscosity.

The core liquid used to form the beads may contain, in addition to the required polyelectrolyte and water, a wide variety of additional materials. Such additional materials useful in bead formation include density modifiers; ionic strength modifiers; active ingredients of the composition described hereinafter; membrane permeability regulators; as well as solvents, dispersants and emuslfiers suitable for dissolving, emulsifying or dispersing all of the components of the bead core liquid into a homogenous fluid.

Preferably the core of the beads used in this invention includes a density modifier in a level such as to reduce the density of the resulting beads by at least about 10%, more preferably at least about 15% at 25° C. The density modifier helps to form beads of predetermined density which can then be suitably suspended in the structured aqueous liquid matrix of the compositions herein. Such density reduction is evaluated by comparing two similar beads, the first one made from a liquid containing a given level of density modifier and the second one from a liquid wherein the density modifier has been substituted by the same weight of water.

Density modifiers are substances preferably having a density of less than about 1000 Kg/m³, more preferably less than about 990 Kg/m³ and higher than about 700 Kg/m³, most preferably higher than about 800 Kg/m³. Suitable density modifiers include hydrophobic materials and materials having a molecular weight higher than about 3,000, preferably higher than about 6,000, more preferably higher than about 10,000. Preferably the density modifier is insoluble but dispersible either with or without the aid of a dispersant agent, in water. Active cleaning composition ingredients can play the role of density modifiers if they fulfill the aforementioned requirements.

Preferred density modifiers for use in the bead core liquids herein include silicone oils, rapseed oil, corn oil, sunflower oil, or any of the other readily available, relatively low cost vegitable oils, petrolactums and low density hydrophobic solvent such as limonene. They are frequently used in amounts which are sufficient to provide beads having densities within the ranges set forth hereinafter for bead density. Typically such density modifier concentrations will range from 5% to 50%, more preferably from 10% to 30% by weight of the core liquid.

The bead core liquid may also comprise various types of essential and/or optional composition active materials. Such materials include those which are hydrophobic, e.g., perfume oils, silicone fluids, surfactants with an HLB below 10, etc. For the purposes of this invention a material is “hydrophobic” if it has an octanol water partition coefficient, expressed as its log to the base 10 or “Clog P” (see GB2 311 296) of greater than 1. The bead core liquid may also comprise high molecular weight (greater than 12,000) hydrophilic materials such as enzymes, can be included in the bead core solution and will then eventually be held within and protected by the membrane-encapsulated beads. Such materials do not readily pass through the bead membrane and will thus be held within the bead core or until the beads disintegrate within the aqueous washing liquor.

The bead core liquid may also contain membrane permeability regulators. These are materials which serve to decrease the permeability of the membranes which eventually form around the bead core liquid when droplets/particles thereof are contacted with the curing bath. When such permeability regulators are included in the bead core liquid, preferably in concentrations ranging from 0.05% to 5% by weight of the core liquid, then it may be possible for hydrophilic composition active materials having molecular weights as low as 10,200 or even as low as 3000 to be incorporated into and held within the bead cores.

One type of useful membrane permeability regulator which can be included in the bead core liquid comprises nanoparticulate or microparticulate material having particle sizes ranging from 1 nm to 10,000 nm, more preferably from 50 nm to 5,000 nm. Nanoparticulate or microparticulate membrane permeability regulators can include materials such as TiO₂ which can also serve as a pigment to color or alter the optical properties of the eventually resulting beads. Other suitable types of nanoparticulate or microparticulate membrane permeability regulators include particles of polyacrylate or other polymeric materials within the size range specified.

The bead core liquid can also comprise a dispersant or emulsifier, especially if any of the other components of the core solution are hydrophobic materials or insoluble nanoparticles or microparticles, in order to facilitate the suspension or emulsification process. Preferred dispersants for use in the bead core liquid include polymers, especially polyvinyl alcohol. Preferred emulsifiers for use in the bead core liquid comprise surfactants. Dispersants and/or emulsifiers are usually used in low levels, suitable levels for use herein being from about 0.1 to about 5%, preferably from about 0.2 to about 3% by weight of the bead core liquid.

The droplets or particles of the bead core liquid, which are added to the curing solution or bath to complete bead formation, are preferably formed by passing such a liquid through one or more nozzles or orifices to form a coherent, preferably laminar-flowing, fluid stream. That fluid stream can then be “cut” into separate droplets/particles by mechanically passing a shearing force through the stream at intervals, preferably regular intervals, along the length of the fluid stream. That shearing force can be provided by a mechanical element such as a knife or rotating wire or can be provided by the shearing action of a cutting fluid such as water or air jet.

The fluid, preferably laminar-flowing, stream into which the bead core liquid is formed can result from simple gravity flow of such a liquid through one or more orifices. More preferably, however, the bead core liquid will be forced through one or more orifices or nozzles by applying pressure to the bulk fluid on one side of the orifices or nozzles. Such pressure application can thus be used to form “jets” of laminar-flowing fluid streams which can be more readily “cut” into droplets or particles of controlled and relatively regular size and configuration. Such fluid steams can, of course, be of any geometric configuration depending on the shape and size of the nozzles or orifices which the fluid flows through and further depending on the extruding pressure used and the rheology of the core liquid.

Most conventionally, the fluid jet stream(s) will be generally cylindrical and the cutting of such fluid jet streams will form, immediately after cutting, droplets or particles in the form of cylindrical segments. As these cylindrical segments fall toward the curing bath into which they are to be dropped, they generally form themselves into substantially spherical droplets due to surface tension effects.

Devices suitable for forming and cutting fluid jets are known in the art and are suitable for forming the beads used in the compositions herein. One such device is available from Genial Lab and is sold under the tradename, Jet Cutter®. Methods and devices for forming beads using the jet-cutter technology are described in greater detail in DE44 24 998 and PCT Patent Publication No. WO 00/48722.

In preferred embodiments using the Jet Cutter® device, the fluid jet stream of the first solution is formed by passing the solution through a nozzle having a diameter of from 0.2 mm to 8 mm, more preferably from 0.5 mm to 4 mm, using a through-put rate of from 0.5 g/s to 20 g/s, more preferably from 1 g/s to 6 g/s. The fluid jet steam is preferably cut by mechanical means, especially preferred being rotating cutting wires having a diameter of from 10 μm to 1,000 μm, more preferably from 50 μm to 500 μm, and having a cutting speed of from 500 rpm to 10,000 rpm, more preferably from 1,000 rpm to 6,000 rpm.

The above bead-forming process is preferably carried out at ambient temperature, this being advantageous when dealing with heat sensitive core liquid materials such as perfumes and enzymes. However, if non-heat sensitive materials are to be encapsulated within the beads, the core liquids of the process can be heated in order to speed the kinetics of the complexation reaction within the curing bath.

The beads of the present invention may contain active ingredients, but may equally provide no chemical benefit whatsoever. Suitable ingredients that may be incorporated into the beads include any ingredient which is incompatible with the ingredients of another phase of the composition. Preferred ingredients for incorporation into the beads include perfume, enzyme, skin conditioning agent and bleach.

Any perfume suitable for perfuming the present composition or enzyme, described in more detail later, may be applied to or into the beads. By skin conditioning agent it is meant a component that improves the barrier health of the skin or provides a superficial skin benefit sensation. Agents providing an improvement in skin barrier health include moisturizers, e.g. oils, glycerin, which replenishes skin lipids, and bioactives that effectively feed the skin nutrients that promote skin health. Examples of bioactives include vitamins, particularly vitamin E and A and vitamin precursors, such as niacinamide.

Agents that provide a superficial benefit sensation to the skin include agents which cool or sooth the skin, but do not clearly aid skin barrier health. Examples include menthols and peppermint, Frescolat®, thymol. Examples of preferred skin conditioning agents include algae, vitamins, Aloe vera and oils, such as sunflower, Aloe vera, grapeseed, jojoba.

Another preferred ingredient for incorporation into the beads is a bleach. Suitable bleaches include hydrophobic bleaches, preferably alkyl peracids and peroxides. The most preferred choice of bleach is a benzoyl peroxide.

Bead Density

The beads useful herein will preferably have a density of from 900 to 1,300 Kg/m³, more preferably from 950 to 1,200 Kg/m³ and most preferably from 980 to 1,100 Kg/m³ at 25° C. As indicated hereinbefore, bead density, along with the rheology of the aqueous liquid matrix of the composition, are interrelated with respect to the ability of the beads to be stably suspended within the liquid compositions. Preferably the beads are indeed suspended so that the liquid compositions are stable for 4 weeks at 25° C. Stability can be evaluated by direct observation or by image analysis, by having colored beads suspended in a transparent liquid contained in a transparent bottle. A freshly made composition of the present invention is considered to be stable if less than 10%, preferably less than 5% and more preferably less than 1% by weight of the beads settle to the bottom of the container after 4 weeks static storage.

Bead Burst Strength

Beads suitable for use in the liquid compositions herein should be physically and chemically compatible with the composition matrix ingredients. Thus within the aqueous liquid matrix of the compositions, the beads are preferably capable of withstanding a force before bursting of from 20 mN to 20,000 mN, more preferably from 50 mN to 15,000 mN and most preferably from 100 mN to 10,000 mN. This strength makes them suitable for industrial handling, including liquid product making processes. They can also withstand pumping and mixing operations without significant breakage and are also stable on transport.

Bead and Bead Making Testing Procedures

The viscosity of the bead core liquid used in the preparation of the preferred beads can be measured using a Physica USD200 controlled stress cup and bob rheometer (Z3-25 mm). A shear rate curve is generated at 25° C. Thirty measurement points of 10 seconds duration are taken between a shear rate of 0.1 s⁻¹ and 100 s⁻¹. From this experimental curve, the viscosity at 1 sec⁻¹ can be extrapolated.

The size and shape of the beads used herein can be characterized using an optical microscope (Leica MZ8) and image analysis system (Leica Q500MC, Quips, UK). Before running the analysis, the beads are taken from a 0.9% sodium chloride solution and placed on the microscope table. During the measurement, the beads are kept wet using a 0.9% sodium chloride solution. Prior to processing of the images, it should be checked to insure that all beads are detected as single entities. The equivalent circle diameter is the diameter of a circle of an equivalent cross sectional area to that of the particle.

The density of the beads herein can be measured using a Helium Pycnometer (Micromeritics AccuPyc 1330) at 21° C. and 25 psi (1760 g/cm2). A bead is taken from a 0.9% sodium chloride storage solution and gently patted with paper tissue to remove excess liquid before the measurement is taken.

The force before bursting that a bead can withstand can be measured by using a Dynamic Mechanical Analyzer (Perkin Elmer DMA 7e). A single bead is separated from the storage liquid (0.9% NaCl) and placed on the parallel sample plate of the analyzer. The bead is covered with a drop of a 0.9% sodium chloride solution. To establish the force at the bursting point, a static strain scan is performed applying an increasing force of 20 mN/minute during the bead compression. The imposed force and the displacement of the squeezed bead are automatically recorded. The point of bursting corresponds to the first shoulder on the static force scan curve and in particular the intersection point of the two tangents costructured as a best fit to the upper and lower lateral portions of the shoulder.

Structurants

The present compositions comprise at least two structuring agents selected from two specific classes of structurant. It is also envisaged that the composition of the present invention may comprise more than two structurants. A structurant is incorporated into a cleaning composition to establish desired rheological characteristics in a liquid product. The result is a product that is aesthetically pleasing from the standpoint of product thickness, product pourability, product optical properties, and especially bead suspension performance. Generally the composition will comprise structurant at a total amount of from 0.01% to 1% by weight, preferably from 0.015% to 0.75% by weight, more preferably from 0.02% to 0.5% by weight, of the compositions herein.

The structurants of the compositions herein are characterized as “external” structurants. An “external” structurant, for the purposes of this invention, is a material which has as its primary function that of providing theological alteration of a liquid matrix. Generally, therefore, an external structurant will not, in and of itself, provide any cleaning benefit or any ingredient solubilization benefit. An external structurant is thus distinct from an “internal” structurant which may also alter matrix rheology but which has been incorporated into the liquid product for some additional primary purpose. Thus, for example, an internal structurant would be anionic surfactants which can serve to alter rheological properties of liquid compositions, but which have been added to the product primarily to act as the cleaning ingredient.

The structurants of the compositions of the present invention are used to alter the rheological characteristics of the aqueous liquid matrix of the compositions described herein. Essential rheological characteristics of the compositions described herein are that they must be pourable and must be capable of stably suspending beads.

The structurants of the present invention preferably provide one or more of the following characteristics:
viscosity to slow down the rate of settling of the beads in the liquid composition; yield stress to provide suspension to non-density matched particles or prevent phase splitting; shear thinning characteristics to provide the necessary aesthetic of a lower viscosity during pouring.

At least one of the structurants of the present invention should be able to produce a composition that is “shear-thinning”. A shear-thinning fluid is one with a viscosity which decreases as shear is applied to the fluid. Thus, at rest, i.e., during storage or shipping of the liquid product, the liquid matrix of the composition should have a relatively high viscosity. When shear is applied to the composition, however, such as in the act of pouring or squeezing the composition from its container, the viscosity of the matrix should be lowered to the extent that dispensing of the fluid product is easily and readily accomplished

The at-rest viscosity of the compositions herein will ideally be high enough to accomplish several purposes. Chief among these purposes is that the composition at rest should be sufficiently viscous to stably suspend the visible beads. A secondary benefit of a relatively high at-rest viscosity is an aesthetic one of giving the composition the appearance of a thick, strong, effective product as opposed to a thin, weak, watery one. Finally, the rheological characteristics of the liquid matrix should be provided via external structurants which do not disdvantageously detract from the visibility of the beads suspended within the composition, i.e., by making the matrix opaque to the extent that the suspended beads are obscured.

The ideal rheological characteristics of the liquid matrix, as provided by the structurants herein in combination with any other ingredients of the matrix, can be quantified by specifying a pouring viscosity, a viscosity under a specified constant stress, and a ratio of these two viscosity values. Both viscosity parameters can be measured for the compositions herein by using a Carrimed CLS 100 Viscometer with a 40 mm stainless steel parallel plate having a gap of 500 microns. All viscosity measurements are taken at 20° C. Such measurements are made on the aqueous liquid matrix without the beads. The pouring viscosity of the liquid matrix of the compositions herein should be measured at a shear rate of 20 sec⁻¹. Preferably the pouring viscosity of the compositions of the present invention is in the range of from 100 to 1500 cps, more preferably from 100 to 1000 cps.

The aqueous liquid matrix of the compositions herein will generally also have specified viscosity characteristics measured under a selected constant stress value. The constant stress value which is selected for the purposes of this invention is 0.1 Pa. That value represents the stress applied to the liquid matrix by a typical bead. The viscosity of the aqueous liquid matrix under a constant stress of 0.1 Pa can be determined using the same Carrimed Viscometer in a creep experiment over a 5 minute interval, again conducted at 20° C. This viscosity should be measured over the 5 minute interval after the matrix has recovered completely from any past high-shear events and has rested at zero shear rate for 10 minutes between loading the sample in the viscometer and running the test. Using this procedure, the viscosity of the matrix determined at the constant stress of 0.1 Pa will preferably be at least 1,500 cps, more preferably at least 10,000 cps, and most preferably even at least 50,000 cps. Finally, to exhibit suitable shear-thinning characteristics for purposes of this invention, the aqueous liquid matrix of the compositions herein should generally have a ratio of its 0.1 Pa.s constant stress viscosity value determined above, to its pouring viscosity value, also determined above, of at least 2. More preferably, this ratio of constant stress viscosity to pouring viscosity will be at least 10. Most preferably this viscosity ratio is significantly higher than either if these values and is at least 1000.

The composition of the present invention comprises at least 2 structurants each providing a different Theological character to the compositions. As discussed above, structurants can be seen to provide structuring during two distinct events, prolonged rest and directly after disruption. As discussed above, the first structuring event is that of providing structuring of the composition immediately or shortly after a deformation event. A deformation event is defined as an action which cause the fluid to deform, flow or more generally be displaced from its initial position; for example, pouring, shaking, squeezing of the composition or a container containing the composition. This structurant may be characterized as possessing a fast recovery or rebuilding time, meaning the time to reestablish its initial state. It can also be envisaged however that further structurants may be added to the composition to provide further structuring events. For example it may be envisaged that a further structurant is included that provides a recovery or rebuilding time even faster than that of the first structurant, or even a structurant the rebuilds the composition even slower than the second structurant.

The first structurant is selected from the group consisting of non-polymeric, crystalline hydroxy-functional materials which can form thread-like structuring systems throughout the liquid matrix when they are crystallized within the matrix in situ. Such materials can be generally characterized as crystalline, hydroxyl-containing fatty acids, fatty esters or fatty waxes. Such materials will generally be selected from those having the following formulas: 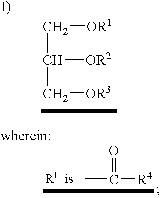
R² is R¹ or H;
R³ is R¹ or H;
R⁴ is independently C₁₀-C₂₂ alkyl or alkenyl comprising at least one hydroxyl group; 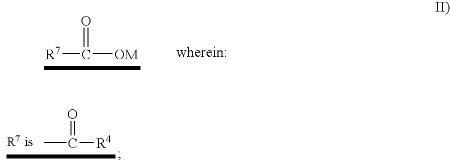
R⁴ is as defined above in i);
M is Na⁺, K⁺, Mg⁺⁺ or Al³⁺, or H; and
   Z-(CH(OH))a-Z′ III)
   where a is from 2 to 4, preferably 2; Z and Z′ are hydrophobic groups, especially selected from C₆-C₂₀ alkyl or cycloalkyl, C₆-C₂₄ alkaryl or aralkyl, C₆-C₂₀ aryl or mixtures thereof. Optionally Z can contain one or more nonpolar oxygen atoms as in ethers or esters.

Materials of the Formula I type are preferred. They can be more particularly defined by the following formula: 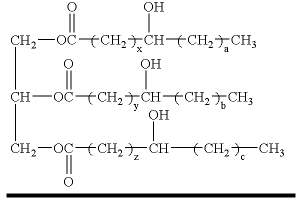
wherein:
(x+a) is from between 11 and 17;
(y+b) is from between 11 and 17; and
(z+c) is from between 11 and 17.

Preferably, in this formula x=y=z=10 and/or a=b=c=5.

Specific examples of preferred crystalline, hydroxyl-containing structurants include castor oil and its derivatives. Especially preferred are hydrogenated castor oil derivatives such as hydrogenated castor oil and hydrogenated castor wax. Commercially available, castor oil-based, crystalline, hydroxyl-containing structurants include THIXCIN® from Rheox, Inc.

Alternative commercially available materials that are suitable for use as crystalline, hydroxyl-containing structurants are those of Formula III hereinbefore. An example of a structurant of this type is 1,4-di-O-benzyl-D-Threitol in the R,R, and S,S forms and any mixtures, optically active or not.

All of these crystalline, hydroxyl-containing structurants as hereinbefore described are believed to function by forming thread-like structuring systems when they are crystallized in situ within the aqueous liquid matrix of the compositions herein or within a pre-mix which is used to form such an aqueous liquid matrix. Such crystallization is brought about by heating an aqueous mixture of these materials to a temperature above the melting point of the structurant, followed by cooling of the mixture to room temperature while maintaining the liquid under agitation.

Under certain conditions, the crystalline, hydroxyl-containing structurants will, upon cooling, form the thread-like structuring system within the aqueous liquid matrix. This thread-like system can comprise a fibrous or entangled thread-like network. Non-fibrous particles in the form of “rosettas” may also be formed. The particles in this network can have an aspect ratio of from 1.5:1 to 200:1, more preferably from 10:1 to 200:1. Such fibers can have a minor dimension which ranges from 1 micron to 100 microns, more preferably from 5 microns to 15 microns.

These crystalline, hydroxyl-containing materials are especially preferred structurants for providing the compositions herein with shear-thinning rheology. They can effectively be used for this purpose at concentrations which are low enough that the compositions are not rendered so undesirably opaque that bead visibility is restricted. These materials and the networks they form also serve to stabilize the compositions herein against liquid-liquid or solid-liquid (except, of course, for the beads and the structuring system particles) phase separation. Their use thus permits the formulator to use less of relatively expensive non-aqueous solvents or phase stabilizers which might otherwise have to be used in higher concentrations to minimize undesirable phase separation. These preferred crystalline, hydroxyl-containing structurants, and their incorporation into aqueous shear-thinning matrices, are described in greater detail in U.S. Pat. No. 6,080,708 and in PCT Publication No. WO 02/40627.

The second structuring event provides the long term structuring of the composition required when the fluid is at rest, for example over prolonged periods of storage. This structurant may be characterised as possessing a long recovery or rebuilding time upon deformation and subsequent rest.

The second structurant is a polymeric structurant selected from the group consisting of polyacrylates and derivatives thereof; polysaccharides and derivatives thereof; polymer gums and combinations thereof. Polyacrylate-type structurants comprise in particular polyacrylate polymers and copolymers of acrylate and methacrylate. An example of a suitable polyacrylate type structurant is Carbopol Aqua 30 available from B.F.Goodridge Company.

Examples of polymeric gums which may be used as the second structurant herein can be characterized as marine plant, terrestrial plant, microbial polysaccharides and polysaccharide derivatives. Examples of marine plant gums include agar, alginates, carrageenan and furcellaran. Examples of terrestrial plant gums include guar gum, gum arabic, gum tragacenth, karaya gum, locust bean gum and pectin. Examples of microbial polysaccharides include dextran, gellan gum, rhamsan gum, welan gum and xanthan gum. Examples of polysaccharide derivatives include carboxymethyl cellulose, methyl hydroxypropyl cellulose, hydroxy propyl cellulose, hydroxyethyl cellulose, propylene glycol alginate and hydroxypropyl guar. The second structurant is preferably selected from the above list or a combination thereof. Preferred polymeris gums include pectine, alginate, arabinogalactan (gum Arabic), carrageenan, gellan gum, xanthan gum and guar gum.

If polymeric gum structurant is employed herein, a preferred material of this type is gellan gum. Gellan gum is a tetrasaccharide repeat unit, containing glucose, glucurronic acid, glucose and rhamrose residues and is prepared by fermentation of Pseudomonaselodea ATCC 31461. Gellan gum is commercially marketed by CP Kelco U.S., Inc. under the KELCOGEL tradename. Processes for preparing gellan gum are described in U.S. Pat. Nos. 4,326,052; 4,326,053; 4,377,636 and 4,385,123.

Optional Ingredients of the Cleaning Composition

The compositions of the present invention may equally comprise optional ingredients as listed below. The essential and optional components of the aqueous liquid compositions herein, as well as composition form, preparation and use, are described in greater detail as follows: (All concentrations and ratios are on a weight basis unless otherwise specified. All documents cited herein are, in relevant part, incorporated herein by reference. The citation of any document is not to be considered as an admission that it is prior art with respect to the present invention.)

Detersive Surfactant

The liquid compositions herein optionally, but preferably comprises a surfactant. More preferably said composition comprises surfactant at a level of from 5% to 50% by weight, preferably from 8% to 40% by weight, more preferably from 10% to 35% by weight, of a certain kind of detersive surfactant component. Said surfactant may be selected from anionic surfactants, nonionic surfactants, amphoteric surfactants, zwitterionic surfactants, cationic surfactants or combinations thereof, although anionic and nonionic surfactants are preferred.

Suitable anionic surfactants useful herein can comprise any of the conventional anionic surfactant types typically used in liquid products. These include the alkyl sulfonic acids, alkyl benzene sulfonic acids, ethoxylated alkyl sulfates and their salts as well as alkoxylated or un-alkoxylated alkyl sulfate materials.

Preferred anionic surfactants are the alkali metal salts of C₁₀₋₁₆ alkyl benzene sulfonic acids, preferably C₁₁₋₁₄ alkyl benzene sulfonic acids. Preferably the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Especially preferred are the sodium and potassium linear straight chain alkylbenzene sulfonates in which the average number of carbon atoms in the alkyl group is from about 11 to 14. Sodium C₁₁-C₁₄, e.g., C₁₂, LAS is especially preferred.

Another preferred type of anionic surfactant comprises ethoxylated alkyl sulfate surfactants. Such materials, also known as alkyl ether sulfates or alkyl polyethoxylate sulfates, are those which correspond to the formula:
R′—O—(C₂H₄O)ₙ—SO₃M
wherein R′ is a C₈-C₂₀ alkyl group, n is from about 1 to 20, and M is a salt-forming cation. Preferably, R′ is C₁₀-C₁₈ alkyl, n is from about 1 to 15, and M is sodium, potassium, ammonium, alkylammonium, or alkanolammonium. Most preferably, R′ is a C₁₂-C₁₆, n is from about 1 to 6 and M is sodium.

The alkyl ether sulfates will generally be used in the form of mixtures comprising varying R′ chain lengths and varying degrees of ethoxylation. Frequently such mixtures will inevitably also contain some unethoxylated alkyl sulfate materials, i.e., surfactants of the above ethoxylated alkyl sulfate formula wherein n=0. Unethoxylated alkyl sulfates may also be added separately to the compositions of this invention and used as or in any anionic surfactant component which may be present.

Preferred unalkoyxylated, e.g., unethoxylated, alkyl ether sulfate surfactants are those produced by the sulfation of higher C₈-C₂₀ fatty alcohols. Conventional primary alkyl sulfate surfactants have the general formula:
ROSO₃⁻M⁺
wherein R is typically a linear C₈-C₂₀ hydrocarbyl group, which may be straight chain or branched chain, and M is a water-solubilizing cation. Preferably R is a C₁₀-C₁₅ alkyl, and M is alkali metal. Most preferably R is C₁₂-C₁₄ and M is sodium.

Suitable nonionic surfactants useful herein can comprise any of the conventional nonionic surfactant types typically used in liquid cleaning compositions. These include alkoxylated fatty alcohols, ethylene oxide (EO)-propylene oxide (PO) block polymers, and amine oxide surfactants.

Preferred for use in the liquid cleaning compositions herein are those nonionic surfactants which are normally liquid.

Preferred nonionic surfactants for use herein include the alcohol alkoxylate nonionic surfactants. Alcohol alkoxylates are materials which correspond to the general formula:
R¹(CₘH₂ₘO)ₙOH
wherein R¹ is a C₈-C₁₆ alkyl group, m is from 2 to 4, and n ranges from about 2 to 12.

Preferably R¹ is an alkyl group, which may be primary or secondary, that contains from about 9 to 15 carbon atoms, more preferably from about 10 to 14 carbon atoms. Preferably also the alkoxylated fatty alcohols will be ethoxylated materials that contain from about 2 to 12 ethylene oxide moieties per molecule, more preferably from about 3 to 10 ethylene oxide moieties per molecule.

The alkoxylated fatty alcohol materials useful in the liquid compositions herein will frequently have a hydrophilic-lipophilic balance (HLB) which ranges from about 3 to 17. More preferably, the HLB of this material will range from about 6 to 15, most preferably from about 8 to 15. Alkoxylated fatty alcohol nonionic surfactants have been marketed under the tradenames Neodol and Dobanol by the Shell Chemical Company.

Another type of nonionic surfactant which is liquid and which may be utilized in the compositions of this invention comprises the ethylene oxide (EO)—propylene oxide (PO) block polymers. Materials of this type are well known nonionic surfactants which have been marketed under the tradename Pluronic. These materials are formed by adding blocks of ethylene oxide moieties to the ends of polypropylene glycol chains to adjust the surface active properties of the resulting block polymers. EO—PO block polymer nonionics of this type are described in greater detail in Davidsohn and Milwidsky; Synthetic Detergents, 7th Ed.; Longman Scientific and Technical (1987) at pp. 34-36 and pp. 189-191 and in U.S. Pat. Nos. 2,674,619 and 2,677,700.

Yet another suitable type of nonionic surfactant useful herein comprises the amine oxide surfactants. Amine oxides are mateials which are often referred to in the art as “semi-polar” nonionics. Amine oxides have the formula: R(EO)ₓ(PO)_{y}(BO)_{z}N(O)(CH₂R′)₂.qH₂O. In this formula, R is a relatively long-chain hydrocarbyl moiety which can be saturated or unsaturated, linear or branched, and can contain from 8 to 20, preferably from 10 to 16 carbon atoms, and is more preferably C₁₂-C₁₆ primary alkyl. R′ is a short-chain moiety preferably selected from hydrogen, methyl and —CH₂OH. When x+y+z is different from 0, EO is ethyleneoxy, PO is propyleneneoxy and BO is butyleneoxy. Amine oxide surfactants are illustrated by C₁₂₋₁₄ alkyldimethyl amine oxide.

In the liquid compositions herein, the detersive surfactant component may preferably comprise combinations of anionic and nonionic surfactant materials. When this is the case, the weight ratio of anionic to nonionic will typically range from 100:1 to 1:100, more typically from 20:1 to 1:20.

The detersive surfactant materials used in the compositions herein may provide an “internal” structuring effect to the aqueous liquid matrix over and above the matrix rheology-modifying contribution provided by the “external” structurant components as defined and described in detail earlier. However, the surfactants used herein will not provide an “internal” structuring effect which, in and of itself, would be sufficient to achieve the desired rheological characteristics of the liquid matrix of the aqueous liquid compositions of this invention.

Solvent

The present compositions may comprise a solvent. Suitable solvents include diols, polymeric glycols and mixtures of both diols and polymeric glycols. Preferred diols include propylene glycol, 1,2 hexanediol, 2-ethyl-1,3-hexanediol and 2,2,4-trimethyl-1,3-pentanediol. Polymeric glycols preferably comprise ethylene oxide (EO) and/or propylene oxide (PO) groups. Polymeric gycols suitable for use in the present invention are of the following formula:
(PO)ₓ(EO)_{y}H
wherein x+y is from 17 to 68, and x/(x+y) is from 0.25 to 1.0. A preferred polymeric glycol is a polyproylene glycol (corresponding to when y≈0) having an average molecular weight of between 1000 to 5000, more preferably between 2000 to 4000, most preferably 2000 to 3000. When diol or polymeric glycols are present the present liquid compositions will contain at least −0.25%, more preferably at least 0.5%, even more preferably still, at least 0.75% by weight of the composition of diol or polymeric glycols. The composition will also preferably contain no more than 5%, more preferably no more than 3%, even more preferably, no more than 2% by weight of the composition.

Other suitable solvents include lower alkanols, diols, other polyols, ethers, amines, and the like may be used in the present invention. Particularly preferred are the C1-C4 alkanols.

Diamines

Where the composition is a hand dishwashing liquid a preferred ingredient thereof is a diamine. Where present the composition will preferably contain at least 0.1%, more preferably at least 0.2%, even more preferably, at least 0.25%, even more preferably still, at least 0.5% by weight of said composition of diamine. The composition will also preferably contain no more than 15%, more preferably no more than 10%, even more preferably, no more than 6%, even more preferably, no more than 5%, even more preferably still, no more than about 1.5% by weight of said composition of diamine.

Preferred organic diamines are those in which pK1 and pK2 are in the range of 8.0 to 11.5, preferably in the range of 8.4 to 11, even more preferably from 8.6 to 10.75. Preferred materials for performance and supply considerations are 1,3-bis(methylamine)-cyclohexane (pKa=10 to 10.5), 1,3 propane diamine (pK1=10.5; pK2=8.8), 1,6 hexane diamine (pK1=11; pK2=10), 1,3 pentane diamine (Dytek EP) (pK1=10.5; pK2=8.9), 2-methyl 1,5 pentane diamine (Dytek A) (pK1=11.2; pK2=10.0). Other preferred materials are the primary/primary diamines with alkylene spacers ranging from C4 to C8. In general, it is believed that primary diamines are preferred over secondary and tertiary diamines.

Definition of pK1 and pK2—As used herein, “pKa1” and “pKa2” are quantities of a type collectively known to those skilled in the art as “pKa” pKa is used herein in the same manner as is commonly known to people skilled in the art of chemistry. Values referenced herein can be obtained from literature, such as from “Critical Stability Constants: Volume 2, Amines” by Smith and Martel, Plenum Press, NY and London, 1975. Additional information on pKa's can be obtained from relevant company literature, such as information supplied by Dupont, a supplier of diamines.

As a working definition herein, the pKa of the diamines is specified in an all-aqueous solution at 25° C. and for an ionic strength between 0.1 to 0.5 M. The pKa is an equilibrium constant which can change with temperature and ionic strength; thus, values reported in the literature are sometimes not in agreement depending on the measurement method and conditions. To eliminate ambiguity, the relevant conditions and/or references used for pKa's of this invention are as defined herein or in “Critical Stability Constants: Volume 2, Amines”. One typical method of measurement is the potentiometric titration of the acid with sodium hydroxide and determination of the pKa by suitable methods as described and referenced in “The Chemist's Ready Reference Handbook” by Shugar and Dean, McGraw Hill, N.Y., 1990.

It has been determined that substituents and structural modifications that lower pK1 and pK2 to below 8.0 are undesirable and cause losses in performance. This can include substitutions that lead to ethoxylated diamines, hydroxy ethyl substituted diamines, diamines with oxygen in the beta (and less so gamma) position to the nitrogen in the spacer group (e.g., Jeffamine EDR 148). In addition, materials based on ethylene diamine are unsuitable.

The diamines useful herein can be defined by the following structure: 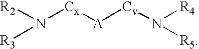
wherein R₂₋₅ are independently selected from H, methyl, —CH₃CH₂, and ethylene oxides; Cₓ and Cᵥ are independently selected from methylene groups or branched alkyl groups where x+y is from 3 to 6; and A is optionally present and is selected from electron donating or withdrawing moieties chosen to adjust the diamine pKa's to the desired range. If A is present, then x and y must both be 1 or greater.

Examples of preferred diamines can be found in the copending provisional patent application of Phillip Kyle Vinson et al., entitled “Dishwashing Detergent Compositions Containing Organic Diamines for Improved Grease Cleaning, Sudsing, Low Temperature Stability and Dissolution”, having P & G Case No. 7167P, application Ser. No. 60/087,693, and filed on Jun. 2, 1998, which is hereby incorporated by reference.

Polymeric Suds Stabilizer

In compositions where the generation and stabilization of suds is important, it is preferred that the composition comprises a polymeric suds stabilizer. These polymeric suds stabilizers provide extended suds volume and suds duration without sacrificing the grease cutting ability of the liquid compositions. These polymeric suds stabilizers are selected from:
i) homopolymers of (N,N-dialkylamino)alkyl acrylate esters having the formula: 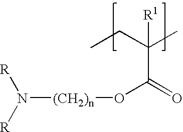
   wherein each R is independently hydrogen, C₁-C₈ alkyl, and mixtures thereof, R¹ is hydrogen, C₁-C₆ alkyl, and mixtures thereof, n is from 2 to 6; and
ii) copolymers of (i) and 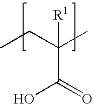
   wherein R¹ is hydrogen, C1-C6 alkyl, and mixtures thereof, provided that the ratio of (ii) to (i) is from 2 to 1 to 1 to 2; The molecular weight of the polymeric suds boosters, determined via conventional gel permeation chromatography, is from 1,000 to 2,000,000, preferably from 5,000 to 1,000,000, more preferably from 10,000 to 750,000, more preferably from 20,000 to 500,000, even more preferably from 35,000 to 200,000. The polymeric suds stabilizer can optionally be present in the form of a salt, either an inorganic or organic salt, for example the citrate, sulfate, or nitrate salt of (N,N-dimethylamino)alkyl acrylate ester.

One preferred polymeric suds stabilizer is (N,N-dimethylamino)alkyl acrylate esters, namely

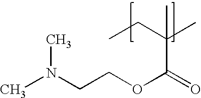

When present in the compositions, the polymeric suds booster may be present in the composition from 0.01% to 15%, preferably from 0.05% to 10%, more preferably from 0.1% to 5%, by weight.

Builders

The compositions according to the present invention may further comprise a builder system. If it is desirable to use a builder, then any conventional builder system is suitable for use herein including aluminosilicate materials, silicates, polycarboxylates and fatty acids, materials such as ethylene-diamine tetraacetate, metal ion sequestrants such as aminopolyphosphonates, particularly ethylenediamine tetramethylene phosphonic acid and diethylene triamine pentamethylene-phosphonic acid. Though less preferred for obvious environmental reasons, phosphate builders can also be used herein.

Suitable polycarboxylates builders for use herein include citric acid, preferably in the form of a water-soluble salt, derivatives of succinic acid of the formula R—CH(COOH)CH₂(COOH) wherein R is C₁₀₋₂₀ alkyl or alkenyl, preferably C₁₂₋₁₆, or wherein R can be substituted with hydroxyl, sulfo sulfoxyl or sulfone substituents. Specific examples include lauryl succinate, myristyl succinate, palmityl succinate 2-dodecenylsuccinate, 2-tetradecenyl succinate. Succinate builders are preferably used in the form of their water-soluble salts, including sodium, potassium, ammonium and alkanolammonium salts.

Other suitable polycarboxylates are oxodisuccinates and mixtures of tartrate monosuccinic and tartrate disuccinic acid such as described in U.S. Pat. No. 4,663,071.

Especially for the liquid execution herein, suitable fatty acid builders for use herein are saturated or unsaturated C₁₀₋₁₈ fatty acids, as well as the corresponding soaps. Preferred saturated species have from 12 to 16 carbon atoms in the alkyl chain. The preferred unsaturated fatty acid is oleic acid. Other preferred builder system for liquid compositions is based on dodecenyl succinic acid and citric acid.

If detergency builder salts are included, they will be included in amounts of from 0.5% to 50% by weight of the composition preferably from 5% to 30% and most usually from 5% to 25% by weight.

Enzymes

Compositions of the present invention may further comprise one or more enzymes which provide cleaning performance benefits. Said enzymes include enzymes selected from cellulases, hemicellulases, peroxidases, proteases, gluco-amylases, amylases, lipases, phospholipases, esterases, cutinases, pectinases, xylanases, keratanases, reductases, oxidases, phenoloxidases, lipoxygenases, ligninases, pullulanases, tannases, pentosanases, mannanases, pentosanases malanases, β-glucanases, arabinosidases, hyaluronidase, chondroitinase, laccase or mixtures thereof. A preferred combination is a composition having a cocktail of conventional applicable enzymes like protease, amylase, lipase, cutinase and/or cellulase. Enzymes when present in the compositions, at from 0.0001% to 5% of active enzyme by weight of the composition. Preferred proteolytic enzymes, then, are selected from the group consisting of Alcalase® (Novo Industri A/S), BPN′, Protease A and Protease B (Genencor), and mixtures thereof. Protease B is most preferred. Preferred amylase enzymes include TERMAMYL®, DURAMYL® and the amylase enzymes those described in WO 9418314 to Genencor International and WO 9402597 to Novo.

Optical Brighteners

Where the composition of the present invention are to be used as laundering products it is preferred that they comprise one or more optical brighteners which provide fabric treatment benefits. Such materials, also known as fluorescent whiting agents (FWAs), are generally deposited onto fabrics or garments being laundered and alter the optical or chromaticity characteristics of the substrates so treated.

Preferred optical brighteners are anionic in character. Many are stilbene derivatives. Examples of such materials include are disodium 4,4′-bis-(2-diethanolamino4-anilino-s-triazin-6-ylamino)stilbene-2:2′ disulphonate, disodium 4,-4′-bis-(2-morpholino4-anilino-s-triazin-6-ylamino-stilbene-2:2′-disulphonate, disodium 4,4′-bis-(2,4-dianilino-s-triazin-6-ylamino)stilbene-2:2′-disulphonate, monosodium 4′,4″-bis-(2,4-dianilino-s-tri-azin-6 ylamino)stilbene-2-sulphonate, disodium 4,4′-bis-(2-anilino4-(N-methyl-N-2-hydroxyethylamino)-s-triazin-6-ylamino)stilbene-2,2′-disulphonate, di-sodium 4,4′-bis-(4-phenyl-2,1,3-triazol-2-yl)-stilbene-2,2′ disulphonate, di-so-dium 4,4′bis(2-anilino4-(1-methyl-2-hydroxyethylamino)-s-triazin-6-ylami-no)stilbene-2,2′disulphonate, sodium 2(stilbyl-4″-(naphtho-1′,2′:4,5)-1,2,3-triazole-2″-sulphonate and 4,4′-bis(2-sulphostyryl)biphenyl. Brighteners have been marketed under the tradeneames Tinopal™ and Brightener No. (#)™ by Ciba-Geigy. They are described in greater detail in European Patent Application EP-A-753 567 and U.S. Pat. No. 5,174,927.

If employed, optical brighteners will typically be incorporated into the liquid laundry compositions herein in concentrations ranging from 0.01% to 1%, preferably from 0.05% to 0.5%, by weight.

Dye Transfer Inhibition Agents

Where the composition is to be used as a laundering detergent, the composition comprises one or more dye transfer inhibition agents which permit desirable laundering of colored fabrics. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. Suitable dye transfer inhibition agents are described in greater detail in U.S. Pat. Nos. 5,783,548; 5,604,194; and 5,466,802. If employed, dye transfer inhibiting agents will typically be incorporated into the liquid compositions herein in concentrations ranging from 0.0001%, more preferably from 0.01%, most preferably from 0.03% by weight to 10%, more preferably to 2%, most preferably to 1% by weight.

Suds Suppressors

Where the presence of suds in the composition is not desirable the composition may comprise a suds suppressor. Frequently, suds suppressor systems are based on silicones or silica-silicone combinations. Examples of suitable suds suppressors for use herein are disclosed in U.S. Pat. Nos. 5,707,950 and 5,728,671. A preferred suds suppressor is a polydimethylsiloxane compounded with silica. If employed, suds suppressors will typically be incorporated into the liquid compositions herein in concentrations ranging from 0.001% to 2% by weight. More preferably, suds suppressors can comprise from 0.01% to 1% by weight of the compositions herein.

Soil Release Polymers

Another preferred ingredient of a laundery detergent according to the present invention is one or more detersive soil release polymers which provide fabric treatment benefits. Polymeric soil release agents useful in the present invention include copolymeric blocks of terephthalate and polyethylene oxide or polypropylene oxide, and the like.

A preferred soil release agent is a copolymer having blocks of terephthalate and polyethylene oxide. More specifically, these polymers are comprised of repeating units of ethylene and/or propylene terephthalate and polyethylene oxide terephthalate at a molar ratio of ethylene terephthalate units to polyethylene oxide terephthalate units of from about 25:75 to about 35:65. This polyethylene oxide terephthalate contains polyethylene oxide blocks having molecular weights of from about 300 to about 2000. The molecular weight of this polymeric soil release agent is in the range of from about 5,000 to about 55,000. Suitable soil release polymers are described in greater detail in U.S. Pat. Nos. 5,574,179; 4,956,447; 4,861,512; and 4,702,857. If employed, soil release polymers will typically be incorporated into the liquid compositions herein in concentrations ranging from 0.01% to 10%, more preferably from 0.1% to 5%, by weight of the composition.

Silicone polymer

An optional although preferred ingredient of the composition when used as toilet bowl cleaner is a silicone polymer. The silicone polymer is believed to deposit onto and coat the surfaces cleaned such as to limit or prevent soil adherence, limescale and/or mineral encrustation build-up. Where present, said compositions may comprise up to 50%, more preferably of from 0.01% to 30%, even more preferably of from 0.01% to 20%, and most preferably of from 0.01% to 10%, by weight of the total composition of said silicone polymer.

Suitable silicone polymers are selected from the group consisting of silicone glycol polymers and mixtures thereof. In a preferred embodiment according to the present invention, the silicone polymer herein is a silicone glycol polymer. Depending on the relative position of the silicone-polyether chains, the silicone glycol polymer can be either linear or grafted. Preferably, said silicone glycol polymer is according to the following formulae: 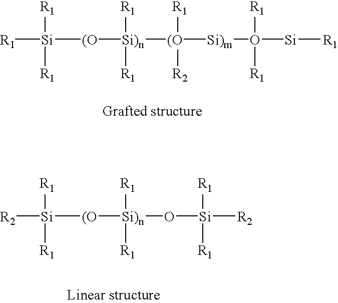
wherein: each R₁ independently is H or a hydrocarbon radical; R₂ is a group bearing a polyether functional group; n is an integer of from 0 to 500; and for the grafted structure m is an integer of from 1 to 300, and preferably with n+m more than 1.

In a highly preferred embodiment herein the silicone polymer herein is a grafted silicone glycol. Preferably, each R₁ independently is H or a hydrocarbon chain comprising from 1 to 16, more preferably a hydrocarbon chain comprising from 1 to 12 carbon atoms, and even more preferably R₁ is a CH₃-group. R₁ can also contain NH₂ groups and/or quaternary ammoniums. Preferably, n is an integer of from 0 to 100, more preferably an integer of from 1 to 100, even more preferably n is an integer of from 1 to 50, and most preferably n is an integer of from 5 to 30. Preferably, m (for the grafted structure) is an integer of from 1 to 80, more preferably m is an integer of from 1 to 30, and even more preferably m is an integer of from 2 to 10. Preferably, n+m is more than 2. Preferably, R₂ is an alkoxylated hydrocarbon chain. More preferably, R₂ is according to the general formulae:
-R₃-(A)ₚ-R₄ or -(A)ₚ-R₄
wherein : R₃ is a hydrocarbon chain; A is an alkoxy group or a mixture thereof; p is an integer of from 1 to 50; and R₄ is H or a hydrocarbon chain, or —COOH. Preferably, R₃ is a hydrocarbon chain comprising from 1 to 12, more preferably 3 to 10, even more preferably from 3 to 6, and most preferably 3 carbon atoms. Preferably, A is an ethoxy or propoxy or butoxy unit or a mixture thereof, more preferably A is an ethoxy group. Preferably, p is an integer of from 1 to 50, more preferably p is an integer of from 1 to 30, and even more preferably p is an integer of from 5 to 20. Preferably, R₄ is H or a hydrocarbon chain comprising from 1 to 12, more preferably 1 to 6, even more preferably from 3 to 6, and still even preferably 3 carbon atoms, most preferably R₄ is H.

Preferably, the silicone glycol polymers suitable herein have an average molecular weight of from 500 to 100,000, preferably from 600 to 50,000, more preferably from 1000 to 40,000, and most preferably from 2,000 to 20,000.

Suitable, silicone glycol polymers are commercially available from General Electric, Dow Coming, and Witco. In a highly preferred embodiment according to the present invention, the polymer herein is a Silicones-Polyethers copolymer, commercially available under the trade name SF 1288® from GE Bayer Silicones.

Other Optional Composition Components

In addition to the ingredients described hereinbefore, the composition herein can optionally contain a wide variety of additional ancillary ingredients. Including for example perfumes, colouring agents, bactericides and other antimicrobials, tarnish inhibitors, buffers, antifungal or mildew control agents, hydrotropes, processing aids, anti-corrosive aids, stabilizers antioxidants, chelants, insect repellents, fabric care or treatment agents providing, for example, fabric softness, anti-static effects, ease-of-ironing benefits, anti-abrasion benefits, anti-pilling effects, color protection, wrinkle removal or improved resistance to wrinkling, fabric substantive perfume or odor benefits, malodor protection benefits, and the like.

Composition Preparation

The aqueous liquid compositions herein can generally be prepared by first forming a pre-mix within which the structurants are dispersed in a portion of the water eventually used to comprise the aqueous liquid matrix of the compositions herein. This pre-mix is formed in such a way that it comprises a structured aqueous liquid.

To this structured pre-mix can then be added, while the pre-mix is under agitation, surfactant(s) and any other ingredient, along with water. Any convenient order of addition of these materials, or for that matter, simultaneous addition of these composition components, to the pre-mix can be carried out. The resulting combination of structured premix with the balance of the composition components forms the aqueous liquid matrix to which the essential visibly distinct beads will be added.

Composition Use

The compositions of this invention, prepared as hereinbefore described, can be used to form aqueous cleaning compositions to be used in a varity of cleaning process, including in particular laundering of fabrics, hand dishwashing and toilet bowl cleaning. The compositions described herein may be mixed with water and then used to contact a surface or alternatively the compositions could be applied to a surface neat. The amount of cleaning composition required will depend on the intended use.

Where the composition is used as a toilet bowl cleaner it is preferred that it is dispensed into the toilet bowl from a dispenser which is attached to the inside rim portion of a lavatory bowl, such that a sufficient amount of the composition is transferred to the lavatory bowl upon flushing of the lavatory bowl with water.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation and the scope of the invention is defined by the appended claims which should be construed as broadly as the prior art will permit.

1. A cleaning composition in the form of a pourable, externally-structured, aqueous liquid matrix having dispersed therein a plurality of stably suspended, visibly distinct beads, said composition comprising;
a) a first structurant selected from the group consisting of non-polymeric crystalline, hydroxy-functional materials which form thread-like structuring systems throughout the aqueous liquid matrix of said composition upon in situ crystallization therein; and
b) a second structurant which is a polymeric structurant selected from the group consisting of polyacrylates and derivatives thereof; polysaccharides and derivatives thereof; polymer gums and combinations thereof.

2. A composition according to claim 1 wherein an active ingredient of the cleaning composition is incorporated on or within said beads.

3. A composition according to claim 1 wherein said beads are stably suspended within said aqueous liquid matrix by means of adjustment of bead density, matrix rheology or both.

4. A composition according to claim 1 wherein the beads are made from agar.

5. A composition according to claim 1 wherein said beads are formed from an anionic polymeric material surrounded by a semi-permeable membrane formed by reacting said anionic polymeric material with a cationic polymeric material.

6. A composition according to claim 1 wherein said beads are formed from a cationic polymeric material surrounded by a semi-permeable membrane formed by reacting said cationic polymeric material with an anionic polymeric material.

7. A composition according to claims 5 or 6 wherein said beads are prepared by a process which comprises mechanical or air-assisted cutting of a fluid jet stream formed from a bead core solution containing one of said anionic or cationic bead polymeric components, to thereby form droplets which are subsequently cured in a curing bath containing the oppositely charged polymeric material.

8. A composition according to claim 1 wherein said beads have an average diameter ranging from 0.2 to 8 millimeters.

9. A composition according to claim 1 wherein said beads have an average burst strength of from 20 mN to 20,000 mN.

10. A composition according to claim 1 wherein the first structurant is selected from one or more compounds of the formulas:
R¹OCH₂CH(OR²)CH₂OR³ or
R⁵C(O)—OM; or
mixtures thereof;
wherein, in these formulas,
R¹ is —C(O)R⁴;
R² is R¹ or H;
R³ is R¹ or H;
R⁴ is independently C₁₀₋₂₂ alkyl or alkenyl comprising at least one hydroxyl;
R⁵ is —C(O)—R⁴; and
M is Na⁺, K⁺, Mg⁺⁺, Al³⁺, or H.

11. A composition according to claim 10 wherein said first structurant is a structurant of the formula: 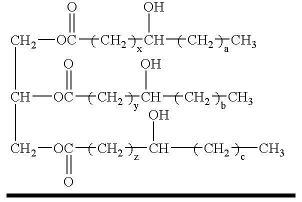
wherein:
(x+a) is from between 11 and 17; (y+b) is from between 11 and 17; and
(z+c) is from between 11 and 17.

12. A composition according to claim 1 wherein the first structurant is selected from the group consisting of crystalline, hydrogenated castor oil or a crystalline, hydrogenated castor oil derivative and mixtures thereof.

13. A composition according to claim 1 wherein the second structurant is selected from gellan gum, guar gum, xanthan gum, gum Arabic and combinations thereof.

14. A composition according to claim 1 wherein said composition is transparent or translucent.
